(19) United States
(12) Patent Application Publication
(10) Pub. No.: US 2012/0194092 A1
(43) Pub. Date: Aug. 2, 2012

(54) DISCHARGE LAMP WITH LONG LIFE

(75) Inventors: Ajaypal S. Naruka, Twinsburg, OH (US); Mark J. Duda, Twinsburg, OH (US)

(73) Assignee: Advanced Lighting Technologies, Inc., Solon, OH (US)

(21) Appl. No.: 13/176,882

(22) Filed: Jul. 6, 2011

Related U.S. Application Data
(60) Provisional application No. 61/437,144, filed on Jan. 28, 2011.

(51) Int. Cl. H05B 41/30; H01J 61/52; H01J 61/35; H01J 61/32; H01J 61/06

(52) U.S. Cl. 315/250; 313/634; 313/631; 313/635; 313/25

(57) ABSTRACT

Methods and apparatuses for starting a discharge lamp are disclosed. In some embodiments, a lamp has an outer envelope connected at one end to a base and enclosing multiple double-ended arc tubes. Each arc tube is electrically connected at one end to an electrical lead positioned proximate the base of the lamp and at the other end to an electrical lead positioned proximate the distal end of the envelope. A voltage pulse is applied to the electrical lead positioned proximate the distal end of the envelope. Random starting of the arc tubes may thus be effected so that each arc tube is about equally likely to start, promoting uniformity of arc tube usage and long lamp life. Multiple arc tubes may be bulbous and staggered in axial displacement for space efficiency, and a diffusing shroud may improve optical characteristics. A heat barrier may facilitate fast restrikes.

### CROSS-REFERENCE TO RELATED APPLICATION

This application claims priority under 35 U.S.C. §119(e) from U.S. Provisional Patent Application Ser. No. 61/437,144 filed Jan. 28, 2011, the entirety of which is hereby incorporated by reference herein.

### BACKGROUND

High-intensity discharge (“HID”) lamps such as metal halide and mercury lamps have found widespread use in lighting large outdoor and indoor areas such as athletic stadiums, gymnasiums, warehouses, parking facilities, and the like, because of the relatively high efficiency, compact size, and low maintenance of HID lamps when compared to other lamp types. Metal halide lamps, which have added metal halide salts, are often preferred because of the efficiency of such lamps in producing white light.

Metal halide lamps may include an arc tube (discharge vessel) with electrodes, an outer lamp envelope that supports the arc tube, a base assembly, and a stem assembly. The base assembly is configured to be secured to a fixture or mount. The stem assembly is coupled to the base assembly and includes stem leads for providing current to the arc tube. The arc tube comprises a generally tubular body of light transmissive material such as quartz or ceramic material which forms a hermetically sealed light emitting chamber containing the lamp fill material and an inert fill gas. Generally, there are several types of arc tube bodies for HID lamps. One type of arc tube body is a “cylindrical” body formed from quartz tubing having the diameter of the generally cylindrical arc tube chamber in which the chamber is formed by pinch-sealing the end portions of the tubing. Another type of arc tube body is a “formed” body which is formed from quartz tubing of a much smaller diameter in which a bulbous light emitting chamber is formed by expansion under internal pressure between two end portions having a reduced tubing diameter. Both cylindrical and formed body arc tubes may also be made from ceramic material. The aforementioned types of arc tube bodies are used in forming “double-ended” arc tubes, i.e., arc tubes having spaced apart electrodes with one sealed at each end. The arc tubes for HID lamps may also be “single-ended” arc tubes having a bulbous chamber sealed at its only end.

An arc tube includes a pair of spaced apart electrodes between which an electric arc is established during operation of the lamp. In a double-ended arc tube, an electrode lead assembly is sealed in each end portion of the arc tube. The electrode lead assembly typically comprises a tungsten electrode, a molybdenum foil, and an outer molybdenum lead. Metal halide lamps produce light by passing the arc through a mixture of gases. In a metal halide lamp, the arc tube typically contains a high-pressure mixture of an inert gas fill (e.g., argon), mercury, and additives such as metal halides. The mixture of halides affects the nature of light produced. The inert gas fill is ionized and facilitates striking the arc across the electrodes when a voltage is applied to the lamp, e.g., from a ballast that regulates current. The heat generated by the arc vaporizes the mercury and metal halides, which produce light as temperature and pressure increases.

Discharge lamps with long life and high lumen maintenance are desirable, especially for applications that are difficult to service. Such applications include high bay lighting, area lighting, post top lighting, street lighting, down lights, and many others. One of the largest costs of replacing a lamp is typically the labor costs associated with physically changing a lamp in a fixture. It is desirable to eliminate or minimize this routine maintenance of a fixture to reduce cost over the life of the fixture while maintaining high light levels.

### SUMMARY

A method of starting a discharge lamp is disclosed. The lamp has an outer envelope connected at one end to a base and enclosing multiple double-ended arc tubes. Each arc tube is electrically connected at one end to an electrical lead positioned proximate the base of the lamp and at the other end to an electrical lead positioned proximate the distal end of the envelope. The method includes applying a voltage pulse to the electrical lead positioned proximate the distal end of the envelope.

In a discharge lamp including an elongated outer envelope and multiple elongated arc tubes enclosed within the outer envelope, each of the arc tubes has a light emitting chamber intermediate a pair of end portions. At least a portion of the light emitting chamber includes a lateral dimension larger than the largest lateral dimension of the end portions. A method performed in the discharge lamp includes positioning the arc tubes within the outer envelope so that a cylindrical boundary having a diameter less than the sum of the largest lateral dimension of each arc tube bounds the arc tubes.

In a discharge lamp including an elongated outer envelope and at least three elongated arc tubes enclosed within the outer envelope, a method includes positioning the arc tubes within the outer envelope so that a cylindrical boundary having a diameter less than the sum of the largest lateral dimension of each arc tube bounds the arc tubes.

In some embodiments, a discharge lamp includes a base, a first electrical lead proximate the base, a second electrical lead remote from the base, and multiple arc tubes electrically connected in parallel between the first and second electrical leads. The second electrical lead is adapted to receive a voltage pulse for effecting an arc in one of the arc tubes.

In some embodiments, a discharge lamp includes a base assembly, a stem assembly coupled to the base assembly, an outer envelope, a flywire, and multiple arc tubes. The stem assembly includes a first stem lead configured to receive a voltage pulse, and a second stem lead. The outer envelope is enclosed at one end by the stem assembly. The flywire is electrically coupled to the first stem lead and extends axially within the envelope. The arc tubes are positioned within the envelope and are electrically connected in parallel between the second stem lead and the flywire.

In some embodiments, a discharge lamp includes an outer envelope and a plurality of elongated arc tubes positioned within said outer envelope. Each arc tube has a light emitting chamber intermediate a pair of end portions. At least a portion of the light emitting chamber includes a lateral dimension larger than the largest lateral dimension of the end portions. The arc tubes are positioned within the outer envelope so that a cylindrical boundary having a diameter less than the sum of the largest lateral dimension of each arc tube bounds the arc tubes.

In some embodiments, a discharge lamp includes an elongated outer envelope and at least three elongated arc tubes positioned within the outer envelope. The arc tubes are positioned within the outer envelope so that a cylindrical boundary having a diameter less than the sum of the largest lateral dimension of each arc tube bounds the arc tubes.

In some embodiments, a discharge lamp includes an elongated outer envelope and multiple arc tubes positioned within the envelope, with the axial position of the arc tubes being staggered. The lamp may also include a light diffusing shroud positioned around the arc tubes.

In some embodiments, a discharge lamp includes an elongated outer envelope, multiple arc tubes positioned within said envelope, and a heat barrier positioned between adjacent arc tubes.

### BRIEF DESCRIPTION OF THE DRAWINGS

The following will be apparent from elements of the figures, which are provided for illustrative purposes and are not necessarily to scale.

FIG. 1 is an illustration of a discharge lamp in accordance with some embodiments having two staggered, bulbous arc tubes.

FIGS. 2A and 2B are illustrations of a discharge lamp in accordance with some embodiments having a thermal barrier, with FIG. 2B showing the lamp of FIG. 2A rotated a quarter turn about its longitudinal axis.

FIGS. 3A and 3B are a side view and a cross-sectional view, respectively, of a discharge lamp in accordance with some embodiments having three staggered, bulbous arc tubes.

FIGS. 4A and 4B are a side view and a cross-sectional view, respectively, of a discharge lamp in accordance with some embodiments having five cylindrical arc tubes in a side by side configuration at equal axial displacement.

FIG. 5 is an illustration of a double-ended discharge lamp in accordance with some embodiments.

FIG. 6 is an illustration of a discharge lamp in accordance with some embodiments having two staggered, bulbous arc tubes and an uncharged frame to which a shroud enclosing the arc tubes is mounted.

FIG. 7 is an illustration of a bi-pin discharge lamp in accordance with some embodiments.

### DETAILED DESCRIPTION

Various embodiments improve upon prior art techniques by facilitating long lamp life, e.g., through the use of multiple arc tubes with random starting, increased efficiency, and superior optical characteristics of generated light output.

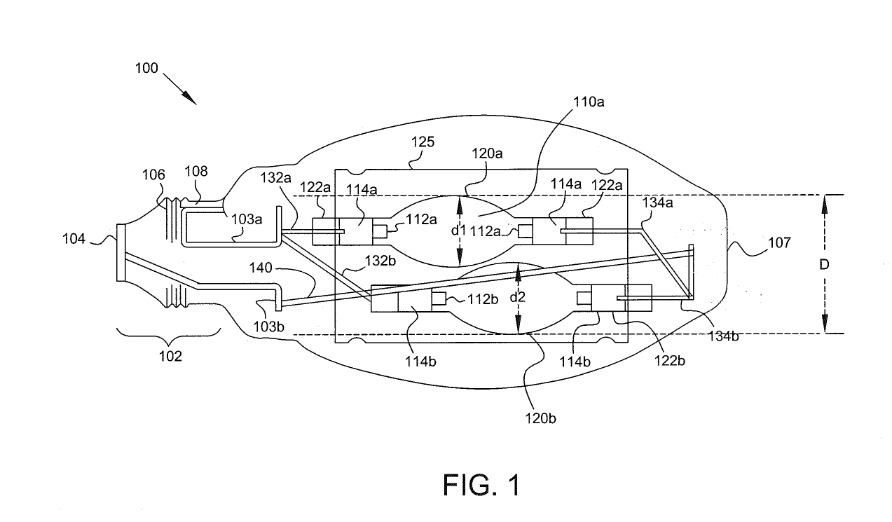

FIG. 1 is an illustration of a lamp 100 in accordance with some embodiments. The lamp 100 includes a base portion 102 (shown at left in the figure) and an outer envelope 105 having a distal end (shown at right). The base 102 includes an eyelet 104, which may include an eyelet electrode, and a shell 106, which may be a screw-type shell that includes a shell electrode 108. The eyelet 104 and 106 may be metallic and may be separated by an electrical insulator, e.g., a glass or ceramic insulator (not shown). The use of an eyelet and shell is known and is described at, e.g., U.S. Pat. No. 4,687,453 to Lekebusch, No. 4,258,288 to Michael, No. 6,147,440 to Scholz, and No. 6,734,633 to Matsuba, the contents of which are hereby incorporated by reference in their entireties. The eyelet 104 and shell 106 provide interfaces for electrical coupling to an external electrical source such as a ballast (not shown). Metal halide light sources are operated with a ballast that uses a pulse of voltage to break down the gap between the two electrodes in an arc tube. A stem assembly includes stem leads 103a and 103b connected to the shell 106 and eyelet 104, respectively. The lamp 100 includes arc tubes 110a and 110b (collectively arc tubes 110), each having a central light-emitting chamber and sealed end portions. In FIG. 1, arc tubes 110a and 110b have respective components labeled with similar reference numerals. The central chambers 120a, 120b (collectively 120) of the arc tubes may be ellipsoidal, bulbous, or cylindrical and the sealed portions 122a, 122b (collectively 122) may be cylindrical. The arc tubes 110 may be surrounded by an optional shroud 125 for open-rated fixture operation or may be unshrouded for enclosed fixture operation. Open-rated and enclosed fixtures are known and are described at, e.g., U.S. Pat. No. 7,187,111 to Johanning, the contents of which are hereby incorporated by reference in their entirety.

Each arc tube 110 may include a pair of electrodes 112, foils (e.g., molybdenum foils) 114, and proximal and distal outer leads. The proximal outer leads 132a and 132b (collectively 132) of respective arc tubes 110a and 110b are coupled to one of the stem leads, and the corresponding distal outer leads 134a and 134b (collectively 134) are coupled to the other stem lead via a flywire 140, which may be a long, elongated wire that extends axially within the outer envelope 105. Foils and electrodes within arc tubes are not identified in subsequent figures to reduce visual clutter.

To start (light) the lamp 100, a voltage pulse may be applied to the electrical leads positioned proximate the distal end 107 of the envelope. For example, in the configuration of FIG. 1, with the proximal outer leads 132 coupled to stem lead 103a, the distal outer leads 134 coupled to stem lead 103b via the flywire 140, and the arc tubes 110 electrically connected in parallel between stem lead 103a and the flywire, a voltage pulse may be applied to the distal outer leads 134. Providing a voltage pulse to the distal leads provides random starting behavior regarding the arc tubes 110. Random starting refers to the characteristic that each arc tube 110 is about equally likely to start (light up). Once one of the arc tubes starts, the other (in a two-arc tube configuration) is shunted due to the parallel coupling configuration of the arc tubes, ensuring only one of the arc tubes is on at a time. Long lifespan is thus provided, as the life of the lamp 100 is effectively doubled relative to a single arc tube configuration. Furthermore, random starting ensures even usage between the arc tubes, further extending lamp life and improving lighting quality. In other words, the lifespan of each arc tube ends at approximately the same time. Since light output from a light source typically decreases as the light source is aged (i.e., lit up), aging the arc tubes in a multiple arc tube lamp in a similar manner has the effect that the overall light level (lumen maintenance) of the lamp is greater than is possible with a traditional single light source lamp for the same time interval.

In some embodiments, the distal leads are coupled to the stem lead that is coupled to the eyelet 104, as shown in FIG. 1. In such a configuration, the voltage pulse is applied to the eyelet. In other embodiments, the wiring configuration may differ from that shown in FIG. 1, and the distal end outer lead of each arc tube may be coupled to the stem lead that is coupled to the shell 106. Wiring configurations may differ based on geographic locales. For example, certain types of ballasts used commonly in the United States (e.g., an HX ballast that uses a 60 Hz pulse) may be associated with random starting behavior when a voltage pulse is applied to the eyelet, whereas reactor ballasts used in Europe that use a 50 Hz pulse may be associated with random starting when a voltage pulse is applied to the shell. Thus, a lamp with multiple arc tubes may be wired differently depending on whether it is to be used in the United States or Europe. The U.S. version of a lamp may have a flywire placed through the eyelet, while a European version may have a non-flywire connection placed through the eyelet.

The discharge lamp 100 may include various types of arc tubes, including but not limited to, metal halide arc tubes, high pressure sodium arc tubes, high pressure mercury arc tubes, high pressure xenon arc tubes, low pressure xenon arc tubes, low pressure sodium arc tubes, low pressure mercury arc tubes, and ultra high pressure (UHP) arc tubes. In some embodiments, the arc tubes 110 are staggered in displacement along the length of the lamp 100, with the chambers 120 of the respective arc tube positioned at a different axial locations within the outer envelope 105. In other embodiments, the arc tubes may be arranged side by side, e.g., with their respective light emitting chambers having midpoints at equal displacement along the longitudinal axis of the lamp. The arc tubes 110 may have bulbous light-emitting chambers, with at least one of the arc tubes having an ellipsoidal or spherical shape.

The arc tubes may be cylindrical or may have other shapes. For example, arc tubes may be symmetrical with regard to proximal (nearer to the base) and distal ends. Arc tubes may be in the shape of rectangular prisms or other prisms that include polygonal (e.g., pentagonal or hexagonal) end faces. Various symmetrical or asymmetrical multifaceted solids may be used for arc tubes. An arc tube may have a cylindrical central chamber and end portions that are spherical, trapezoidal, or some other shape. Arc tubes may also be asymmetric in one direction, e.g., shaped like a carrot, a tear drop, or a conical or polyhedral frustum, or asymmetric in both axial directions (e.g., shaped in one way near one axial end and shaped in another way near the other axial end).

Staggering bulbous arc tubes as in FIG. 1 provides more efficient usage of space within the outer envelope 105 than has been available previously. In FIG. 1, for each tube the diameter of the central chamber is greater than the diameter of the cylindrical end portions. By staggering the arc tubes in axial displacement, end portion 114b of arc tube 110b is positioned at a similar axial displacement as chamber 120a of arc tube 110a, and end portion 114a is positioned at a similar displacement as chamber 120b. Thus, the arc tubes occupy less space (volume) than they would if they were positioned side by side. As shown by dashed lines in FIG. 1, an imaginary cylinder of minimal diameter that bounds the arc tubes 110 may have a diameter D that is less than the sum of the largest lateral dimension of each arc tube (d1 and d2 for arc tubes 110a and 110b, respectively), i.e., D<d1+d2. The smallest possible imaginary cylinder (in terms of diameter) that bounds the arc tubes in some embodiments has a smaller diameter than such a minimal cylinder would have in accordance with conventional approaches.

The lamp 100 may include a shroud 125, which may be a cylindrical shroud that surrounds the arc tubes 110 as shown in FIG. 1. The shroud is configured to diffuse light emitted by any of the arc tubes. In some embodiments, the shroud may be a sandblasted quartz shroud that is impaled with a fine grit sand traveling at a high velocity. The sand roughens the surface of the quartz, creating irregularities on the surface of the shroud that scatter the light from the arc tubes. Without a diffusing shroud (i.e., in conventional lighting systems), the light output appears to originate from different axial positions when one arc tube is lit as compared to another arc tube as a result of the staggered positioning of arc tubes. The scattering of the light by the shroud promotes optical uniformity and an optically smaller light source at the expense of reduced light output, so that an observer may not perceive a difference between light output from various arc tubes.

The shroud 125 may also be formed from glass or a ceramic or polymeric material. In some embodiments, the shroud 125 may be a chemically etched shroud, a shroud coated with a thin film (e.g., a phosphor coating), a shroud found from a translucent or transparent material, or another type of shroud that diffuses light so as to promote uniform light output when various arc tubes are lit. The shroud may be multifaceted instead of cylindrical. Shrouds have previously been used in conventional lighting systems to protect in the event of a non-passive failure of an open-rated fixture, but they have not been used for light diffusion, because multiple staggered arc tubes have not previously been used. Because of the reduced light output associated with a diffusing shroud, single arc tube open-rated lamps have typically not used a diffusing shroud.

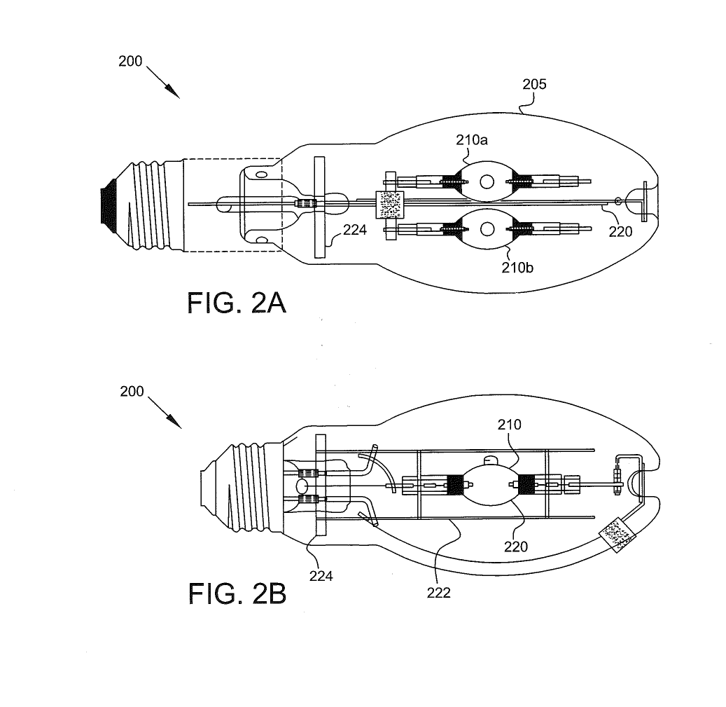

Some embodiments include one or more heat barriers between adjacent arc tubes to allow for fast restrike of the lamp. Referring to FIGS. 2A and 2B, a lamp 200 includes a heat barrier 220 that is mounted by a frame 222 to a heat barrier support 224. FIG. 2B shows the lamp of FIG. 2A rotated a quarter turn (90 degrees) about its longitudinal axis. The heat barrier 220 is positioned between arc tubes 210a and 210b. When one of the arc tubes (e.g., arc tube 210a) is on, the other (e.g., arc tube 210b) is kept relatively cool due to thermal insulation provided by the heat barrier 220. Traditionally, in multiple arc tube lamps, an inactive arc tube increases in temperature when an adjacent arc tube is lit. When the lit arc tube in such a conventional lamp turns off (e.g., due to failure or intentional de-activation), the formerly inactive arc tube typically requires a cooling-off period before it may be lit. In various embodiments, the heat barrier 220 ensures that an inactive arc tube is kept relatively cool and may be lit without delay in the event that an active are tube turns off. The heat barrier may 220 may be formed from any of various thermally insulating materials, e.g., quartz, glass, ceramic, or polymeric materials, ferrous metals such as various steels, non-ferrous materials such as aluminum, brass, or copper, a high temperature fibrous material such as heat tape or sleeving, or a carbon sheet or carbon fiber.

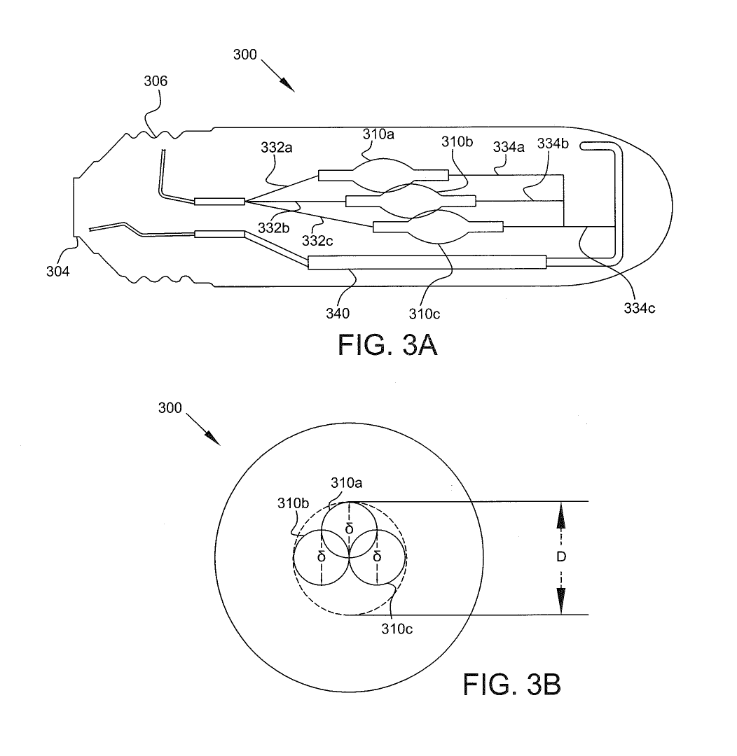

In some embodiments, more than two arc tubes are included within the envelope of a discharge lamp. In FIG. 3A, a discharge lamp 300 is shown having three bulbous arc tubes 310a, 310b, and 310c (collectively 310) staggered in axial displacement. FIG. 3B shows a cross-sectional view of the lamp 300, with the arc tubes 310 configured in a triangular arrangement. The proximal outer leads 332a, 332b, 332c of respective arc tubes 310a, 310b, 310c are coupled to an electrode at the shell 306 of the base, and the corresponding distal outer leads 334a, 334b, 334c are coupled via a mount 340 to an electrode at the eyelet 304 of the base. A voltage pulse may be applied to the distal outer leads (e.g., by applying the voltage pulse to the electrode at the eyelet), providing random starting functionality with regard to the arc tubes 310a, 310b, and 310c. In this way, each arc tube has about a 33% chance of lighting when the lamp is activated. In this example, a shroud is not present, but a diffusing shroud may be used with similar properties as described above.

In a discharge lamp having at least three arc tubes, space efficiency may be achieved by positioning the arc tubes such that an imaginary cylindrical boundary having a diameter less than the sum of the largest lateral dimension of each arc tube bounds the arc tubes. In some embodiments, an imaginary cylindrical boundary having a diameter less than the sum of the largest lateral dimension of two of the arc tubes bounds the arc tubes. For example, referring to FIG. 3B, each arc tube 310a, 310b, 310c has largest lateral dimension 6, and an imaginary bounding cylinder of minimal diameter (shown with dashed lines) that bounds the arc tubes may have a diameter D that is less than 36 or 26 in some embodiments.

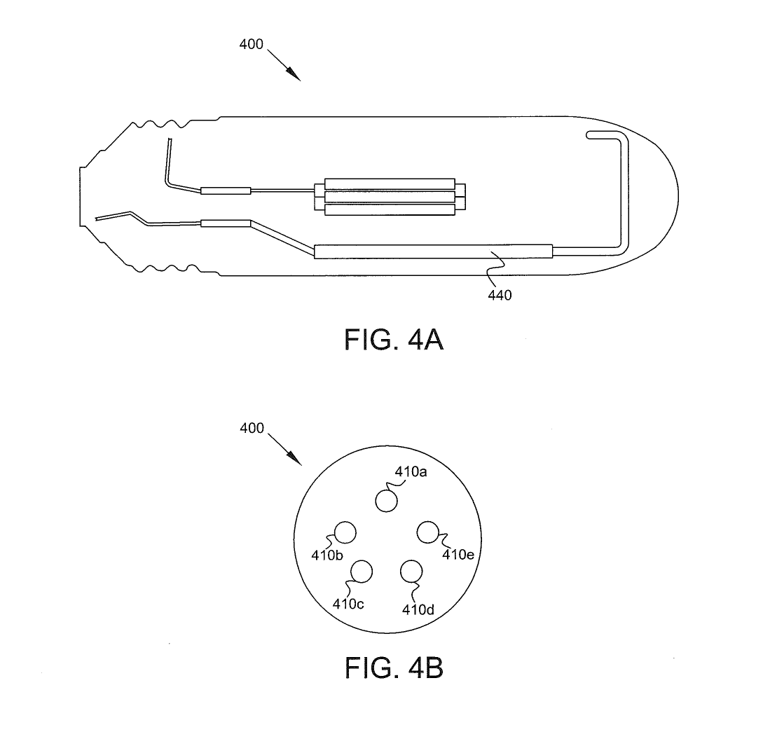

Four arc tubes may be used, in which case they may be positioned such that their respective centers in a cross-sectional view are located at corners of a square. Five arc tubes may be used as shown in FIGS. 4A and 4B. In this example, cylindrical arc tubes are positioned side by side (at equal axial displacements), with their respective centers in the cross-sectional view of FIG. 4B located at vertices of a pentagon. Thus, various numbers of arc tubes may be used in a multiple arc tube discharge lamp, and the arc tubes may be staggered in displacement or side by side. In each case, applying a voltage to the distal outer leads of arc tubes providing advantageous random starting behavior that results in each arc tube having an approximately random chance of starting, promoting long life and even usage of arc tubes.

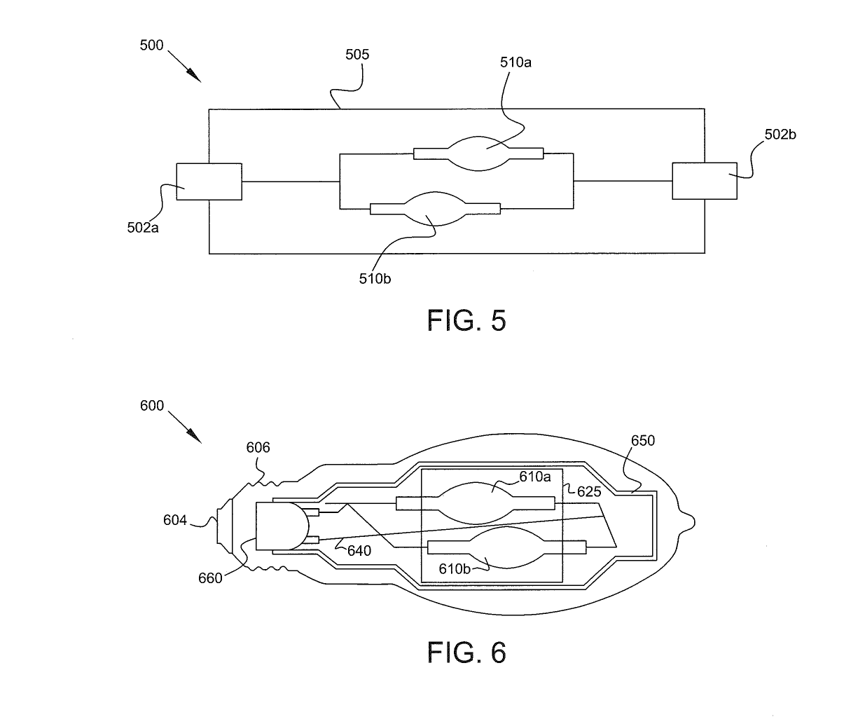

In some embodiments, a double-ended lamp includes multiple arc tubes. For example, FIG. 5 shows a double-ended lamp 500 having an envelope 505 and bases 502a and 502b providing interfaces for electrical coupling. Bulbous arc tubes 510a and 510b are staggered in axial displacement in this example.

In some embodiments, an uncharged (floating) frame or mount is used to prevent or reduce photoemission of electrons responsible for sodium loss. In FIG. 6, a lamp 600 includes arc tubes 610a and 610b enclosed by a shroud 625 that is secured by a mount (frame) 650 affixed to a stem 660. Distal outer leads of respective arc tubes 610a and 610b are coupled via a flywire 640, which passes between the arc tubes, to an electrode at eyelet 604. The corresponding proximal outer leads are coupled to an electrode at the shell 606. Electricity is conducted by the flywire, and the frame 650 is uncharged. Traditionally, if ultraviolet radiation from an arc tube strikes a charged frame, electrons are displaced from the surface of the frame, causing a skin of negative charge to accumulate on the surface of the frame. In the case of a metal halide lamp employing sodium, sodium ions are formed by dissociation. Sodium ions, which are small, may then migrate through gaps in the outer envelope, which may be formed from quartz. Thus, sodium leaks out of the arc tube, as the conventional charged frame provides electrical bias, degrading performance.

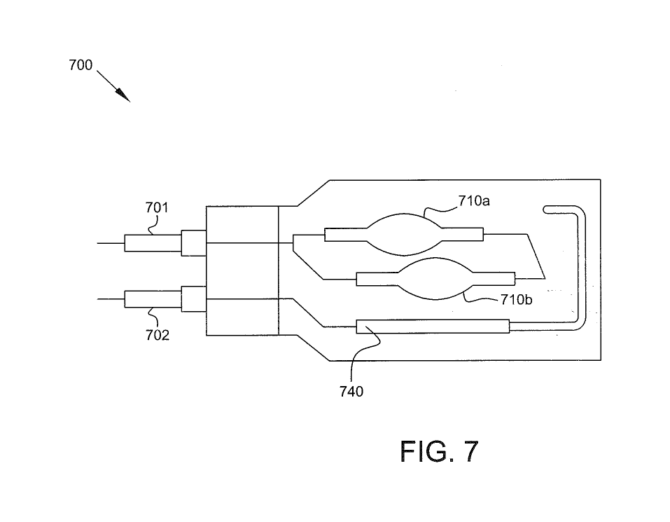

In some embodiments, a bi-pin lamp configuration may be used. In FIG. 7, a discharge lamp 700 is shown in a bi-pin configuration with pins 701 and 702. Bulbous arc tubes 710a and 710b are staggered in axial displacement, with the proximal outer leads of each arc tube coupled to pin 710 and the distal outer leads of each arc tube coupled via a mount 740 to pin 702.

Although examples are illustrated and described herein, embodiments are nevertheless not limited to the details shown, since various modifications and structural changes may be made therein by those of ordinary skill within the scope and range of equivalents of the claims.

What is claimed is:

1. A method of starting a discharge lamp having an outer envelope connected at one end to a base and enclosing a plurality of double-ended arc tubes, each of said arc tubes being electrically connected at one end to an electrical lead positioned proximate the base of the lamp and at the other end to an electrical lead positioned proximate the distal end of the envelope, the method comprising applying a voltage pulse to the electrical lead positioned proximate the distal end of the envelope.

2. The method of claim 1 wherein the electrical lead positioned proximate the distal end of the envelope is electrically connected to the eyelet of the lamp base.

3. The method of claim 1 wherein the electrical lead positioned proximate the distal end of the envelope is electrically connected to the shell of the lamp base.

4. The method of claim 1 wherein the discharge lamp includes a plurality of metal halide arc tubes.

5. The method of claim 1 wherein the discharge lamp includes a plurality of high pressure sodium arc tubes.

6. The method of claim 1 wherein the discharge lamp includes a plurality of high pressure mercury arc tubes.

7. The method of claim 1 wherein the discharge lamp includes a plurality of low pressure sodium arc tubes.

8. The method of claim 1 wherein the discharge lamp includes a plurality of low pressure mercury arc tubes.

9. The method of claim 1 wherein the discharge lamp includes a plurality of high pressure xenon arc tubes.

10. The method of claim 1 wherein the discharge lamp includes a plurality of ultra performance (UHP) arc tubes.

11. In a discharge lamp comprising an elongated outer envelope and a plurality of elongated arc tubes enclosed within the outer envelope, each of the arc tubes having a light emitting chamber intermediate a pair of end portions wherein at least a portion of the light emitting chamber includes a lateral dimension larger than the largest lateral dimension of the end portions, a method comprising positioning the arc tubes within the outer envelope so that a cylindrical boundary having a diameter less than the sum of the largest lateral dimension of each arc tube bounds the plurality of arc tubes.

12. The method of claim 11 wherein the light emitting chamber of each arc tube is bulbous and positioning the arc tubes comprises positioning the bulbous chambers of each arc tube at differing axial locations within the outer envelope.

13. The method of claim 12 wherein the light emitting chamber of at least one arc tube is ellipsoidal.

14. The method of claim 13 wherein the light emitting chamber of at least one arc tube is spherical.

15. The method of claim 11 wherein the lamp comprises three arc tubes and wherein the cylindrical boundary bounding the plurality of arc tubes has a diameter less than the sum of the largest lateral dimension of two of the arc tubes.

16. The method of claim 15 wherein the light emitting chambers of the arc tubes are ellipsoidal.

17. The method of claim 16 wherein the light emitting chambers of the arc tubes are spherical.

18. The method of claim 11 wherein the axial dimension from the end portion of an arc tube nearest one end of the lamp to the end portion of an arc tube nearest the other end of the lamp is less than the sum of the length of each arc tube.

19. The method of claim 11 wherein the outer envelope is connected at one end to a base.

20. The method of claim 11 wherein the outer envelope is connected at each end to a base.

21. In a discharge lamp comprising an elongated outer envelope and at least three elongated arc tubes enclosed within the outer envelope, a method comprising positioning the arc tubes within the outer envelope so that a cylindrical boundary having a diameter less than the sum of the largest lateral dimension of each arc tube bounds the arc tubes.

22. The method of claim 21 wherein a cylindrical boundary having a diameter less than the sum of the largest lateral dimension of two of the arc tubes bounds the arc tubes.

23. The method of claim 21 wherein each arc tube is cylindrical.

24. The method of claim 21 wherein each arc tube has a symmetric shape including a first shape for a center of said arc tube and a second shape for end portions of said arc tube.

25. The method of claim 24 wherein the first shape is a cylinder and the second shape is a sphere.

26. The method of claim 24 wherein the first shape is a cylinder and the second shape is a polyhedron.

27. The method of claim 21 wherein each arc tube has an asymmetric shape

28. The method of claim 27 wherein a first end portion of said arc tube has a first shape and a second end portion of said arc tube has a second shape.

29. The method of claim 21 wherein each arc tube has a prism shape.

30. A discharge lamp comprising:
a base;
a first electrical lead proximate said base;
a second electrical lead remote from said base; and
a plurality of arc tubes electrically connected in parallel between said first and second electrical leads,
wherein said second electrical lead is adapted to receive a voltage pulse for effecting an arc in one of said arc tubes.

31. The lamp of claim 30 wherein said base comprises an eyelet electrode and a shell electrode wherein said second electrode is electrically connected to said eyelet electrode and said first electrode is electrically connected to said shell electrode.

32. The lamp of claim 31 wherein said base comprises an eyelet electrode and a shell electrode wherein said second electrode is electrically connected to said shell electrode and said first electrode is electrically connected to said eyelet electrode.

33. The lamp of claim 31 wherein said arc tubes are metal halide arc tubes.

34. The lamp of claim 31 wherein said arc tubes are high pressure sodium arc tubes.

35. A discharge lamp comprising:
a base assembly;
a stem assembly coupled to said base assembly, said stem assembly including a first stem lead configured to receive a voltage pulse, and a second stem lead;
an outer envelope enclosed at one end by said stem assembly;
a flywire electrically coupled to said first stem lead and extending axially within said envelope; and
a plurality of arc tubes positioned within said envelope and electrically connected in parallel between said second stem lead and said flywire.

36. The discharge lamp of claim 35 wherein said base assembly comprises an eyelet electrode and a shell electrode, said first stem lead being electrically connected to said eyelet electrode and said second stem lead being electrically connected to said shell electrode.

37. The discharge lamp of claim 36 wherein said base assembly comprises an eyelet electrode and a shell electrode, said second stem lead being electrically connected to said eyelet electrode and said first stem lead being electrically connected to said shell electrode.

38. The discharge lamp of claim 36 wherein said arc tubes comprise bulbous light emitting chambers and wherein longitudinally central portions of said light emitting chambers are positioned in differing axial positions within said outer envelope.

39. The discharge lamp of claim 38 further comprising a cylindrical shroud positioned around said plurality of arc tubes.

40. The discharge lamp of claim 39 wherein said shroud is configured to diffuse light emitted by any of said arc tubes.

41. The discharge lamp of claim 38 comprising at least three arc tubes.

42. The discharge lamp of claim 36 further comprising a cylindrical shroud positioned around said plurality of arc tubes.

43. A discharge lamp comprising an outer envelope and a plurality of elongated arc tubes positioned within said outer envelope, each of said arc tubes having a light emitting chamber intermediate a pair of end portions wherein at least a portion of the light emitting chamber includes a lateral dimension larger than the largest lateral dimension of the end portions, wherein said arc tubes are positioned within said outer envelope so that a cylindrical boundary having a diameter less than the sum of the largest lateral dimension of each arc tube bounds said plurality of arc tubes.

44. The discharge lamp of claim 43 wherein the light emitting chamber of each of said arc tubes is bulbous and said arc tubes are positioned at differing axial locations within said outer envelope.

45. The discharge lamp of claim 44 wherein the light emitting chamber of at least one of said arc tubes is ellipsoidal.

46. The discharge lamp of claim 45 wherein the light emitting chamber of at least one of said arc tubes is spherical.

47. The discharge lamp of claim 43 wherein the lamp comprises three arc tubes and wherein said cylindrical boundary bounding said plurality of arc tubes has a diameter less than the sum of the largest lateral dimension of two of said arc tubes.

48. The discharge lamp of claim 47 wherein the light emitting chambers of said arc tubes are ellipsoidal.

49. The discharge lamp of claim 48 wherein the light emitting chambers of said arc tubes are spherical.

50. The discharge lamp of claim 43 wherein the axial dimension from the end portion of an arc tube nearest one end of said outer envelope to the end portion of an arc tube nearest the other end of said outer envelope is less than the sum of the length of each arc tube.

51. The discharge lamp of claim 43 wherein the outer envelope is connected at one end to a base.

52. The discharge lamp of claim 43 wherein the outer envelope is connected at each end to a base.

53. A discharge lamp comprising an elongated outer envelope and at least three elongated arc tubes positioned within the outer envelope, said arc tubes being positioned within said outer envelope so that a cylindrical boundary having a diameter less than the sum of the largest lateral dimension of each arc tube bounds said arc tubes.

54. The discharge lamp claim 53 wherein said cylindrical boundary has a diameter less than the sum of the largest lateral dimension of two of said arc tubes.

55. A discharge lamp comprising an elongated outer envelope and a plurality of arc tubes positioned within said envelope, the axial position of said arc tubes being staggered.

56. The discharge lamp of claim 55 further comprising a light diffusing shroud positioned around said plurality of arc tubes.

57. The discharge lamp of claim 56 wherein said shroud is formed by a sandblasted quartz, glass, ceramic, or polymeric material.

58. The discharge lamp of claim 56 wherein said shroud is formed by a chemically etched quartz, glass, ceramic, or polymeric material.

59. The discharge lamp of claim 56 wherein said shroud is formed by a thin film coating on a quartz, glass, ceramic, or polymeric material.

60. The discharge lamp of claim 56 wherein said shroud is a multifaceted quartz, glass, ceramic, or polymeric material.

61. The discharge lamp of claim 56 wherein said shroud is transparent.

62. The discharge lamp of claim 56 wherein said shroud is translucent.

63. The discharge lamp of claim 55 wherein at least one of said arc tubes includes a light emitting chamber having a shape from the group consisting of ellipsoidal, spherical, cylindrical, symmetrical about a longitudinal axis, asymmetrical about a longitudinal axis, polyhedral, symmetrical about a lateral axis, and asymmetrical about a lateral axis.

64. The discharge lamp of claim 55 wherein at least one arc tube is a metal halide arc tube, high pressure sodium arc tube, high pressure mercury arc tube, high pressure xenon arc tube, low pressure xenon arc tube, low pressure sodium arc tube, low pressure mercury arc tube, or a ultra high performance (UHP) arc tube.

65. A discharge lamp comprising an elongated outer envelope, a plurality of arc tubes positioned within said envelope, and a heat barrier positioned between adjacent arc tubes.

66. The discharge lamp of claim 65 wherein said heat barrier is formed from a quartz material.

67. The discharge lamp of claim 65 wherein said heat barrier is formed from a glass material.

68. The discharge lamp of claim 65 wherein said heat barrier is formed from a ceramic material.

69. The discharge lamp of claim 65 wherein said heat barrier is formed from a polymeric material.

70. The discharge lamp of claim 65 wherein said heat barrier is formed from a ferrous metal.

71. The discharge lamp of claim 65 wherein said heat barrier is formed from a non-ferrous material.

72. The discharge lamp of claim 65 wherein said heat barrier is formed from a high temperature fibrous material.

73. The discharge lamp of claim 65 wherein said heat barrier is formed from a carbon sheet or carbon fiber.
